(19) United States
(12) Patent Application Publication
(10) Pub. No.: US 2009/0060557 A1
(43) Pub. Date: Mar. 5, 2009

(54) IMAGE FORMING APPARATUS AND IMAGE FORMING METHOD

(76) Inventor: Masaaki GOTO, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/026,211

(22) Filed: Feb. 5, 2008

(30) Foreign Application Priority Data
Sep. 3, 2007 (JP) JP2007-228054

(51) Int. Cl. G03G 15/00

(52) U.S. Cl. 399/88

(57) ABSTRACT

An image forming apparatus provided with an image forming section and a fixing section, comprising: a memory section which stores relationships between a plurality of instruction forms of image formation and a plurality of power supply methods including a power supply by both an AC power source and a capacitor to the fixing section and a power supply only by the AC power source to the fixing section; and a controller, when receiving an instruction of image formation, that refers to the memory section on a basis of an instruction form of the received instruction of image formation and supplies power by both the AC power source and capacitor to the fixing section, or supplies power only by the AC power source to the fixing section.

### RELATED APPLICATION

This application is based on Japanese Patent Application No. 2007-228054 filed on Sep. 3, 2007 in Japanese Patent Office, the entire content of which is hereby incorporated by reference.

### BACKGROUND

1. Technical Field

The present invention relates to an image forming apparatus such as a copier, a printer, a facsimile, or a multifunctional peripheral thereof and more particularly to an image forming apparatus which supplies power to a fixing section, thereby warming up the fixing section and an image forming method.

2. Related Art

The image forming apparatus, when a main power source is turned on, supplies power to the fixing section and raises the temperature of the fixing section to a predetermined temperature. By doing this, the image forming apparatus is warmed up and the condition of the apparatus is transferred to the standby mode. The image forming apparatus, upon receipt of a print job in the standby mode, transfers the condition thereof from the standby mode to the print mode and outputs an image. Further, when a predetermined period of time elapses after output of the image, the image forming apparatus stops the power supply to the fixing section. By doing this, the condition of the image forming apparatus is transferred to the energy conservation mode. The image forming apparatus, upon receipt of the print job in the energy conservation mode, supplies power to the fixing section and raises the lowered temperature of the fixing section to the predetermined temperature. By doing this, the image forming apparatus is warmed up and the condition of the image forming apparatus is transferred to the standby mode. Thereafter, the condition is transferred from the standby mode to the print mode and the image forming apparatus outputs an image.

In the conventional image forming apparatus, as an art for shortening the time required up to output of an image, an art for supplying a large capacity of power from both the AC power source and capacitor to the heating element of the fixing section is adopted (for example, refer to Unexamined Japanese Patent Application Publication No. 2000-315567). By use of the art, it is possible to raise rapidly the fixing section to the predetermined temperature, thereby shorten the time required for warm-up. Further, an art for supplying power from both the AC power source and capacitor to the heating element and then depending on the condition of the fixing section or capacitor, adjusting the power supply from the capacitor is adopted (for example, refer to Unexamined Japanese Patent Application Publication No. 2002-184554). Furthermore, an art, when the charging quantity of the capacitor reaches the specified value, for supplying power from both the AC power source and capacitor to the heating element and when the charging quantity of the capacitor is lower than the specified value, for supplying power only from the AC power source to the heating element is proposed (for example, refer to Unexamined Japanese Patent Application Publication No. 2003-257590).

Further, when turning on the main power source and then warming up the apparatus, even if power is supplied from both the AC power source and capacitor to the heating element, it takes a lot of time in the processes other than that for the fixed section such as startup of the other units and the control section itself of the image forming apparatus, thus it may be difficult to shorten the time required for warm-up. Therefore, an art, when turning on the main power unit and then warming up the apparatus, for supplying power only from the AC power source to the heating element and when transferring the energy conservation mode to the standby mode, for supplying power from both AC power source and capacitor to the heating element, thereby shortening the time required for warm-up (for example, refer to Unexamined Japanese Patent Application Publication No. 2006-58731).

Therefore, to use the capacitor, a charger is used always. The power conversion efficiency of the charger from the AC power source is about 70%, so that use of the capacitor is accompanied by a power loss due to use of charger. On the other hand, when supplying directly power from the AC power source to the heating element, no power loss due to use of the charger is caused. Therefore, to promote more the energy conservation, it is desirable to avoid use of the capacitor as far as possible.

On the other hand, when transferring the condition of the image forming apparatus from the energy conservation mode to the standby mode, there is not always a demand of a user for immediate output of an image. For example, in reception of a facsimile, there is the present condition of perceiving of reception of a facsimile by output of an image, thus the necessity of shortening the time required for warm-up is low. Further, when using a weekly timer for starting the image forming apparatus due to the incoming of the preset day of the week or the preset time, the image forming apparatus is started a little early, thus the image forming apparatus may be warmed up, so that the necessity of shortening the time required for warm-up is low.

However, according to the image forming apparatuses described in Unexamined Japanese Patent Application Publication No. 2000-315567 and Unexamined Japanese Patent Application Publication No. 2002-184554, although the necessity of shortening the time required for warm-up is low, since the capacitor is used, a power loss is caused. Further, according to the image forming apparatus described in Unexamined Japanese Patent Application Publication No. 2003-257590, depending on the charging quantity of the capacitor, whether or not to use the capacitor is decided. However, there are not always few cases of using no capacitor, so that the effect of energy conservation is low. Furthermore, according to the image forming apparatus described in Unexamined Japanese Patent Application Publication No. 2006-58731, only when it is difficult to shorten the time required for warm-up, the warm-up is executed without using the capacitor. In this case, the opportunity of executing warm-up using the capacitor is increased, so that the effect of energy conservation is small. Further, the warm-up using no capacitor is equivalent to the warm-up after turning on the main power source. The number of times of warm-up is almost once per day, so that the effect of the energy conservation is not always high.

The present invention was developed to solve the aforementioned problem and is intended to provide an image forming apparatus and an image forming method for avoiding use of the capacitor as far as possible when supplying power to the fixing section, thereby reducing the power loss due to the capacitor.

### SUMMARY

According to one aspect of the invention, there is provided an image forming apparatus having an image forming section and fixing section, the image forming apparatus comprises: a memory section which stores relationships between a plurality of instruction forms of image formation and a plurality of power supply methods including a power supply by both an AC power source and a capacitor to the fixing section and a power supply only by the AC power source to the fixing section; and a controller, when receiving an instruction of image formation, that refers to the memory section on a basis of the received instruction form of image formation and supplies power by both the AC power source and capacitor to the fixing section, or supplies power only by the AC power source to the fixing section.

According to another aspect of the invention, there is provided an image forming method, the method comprising: receiving an instruction of image formation and judging whether a condition of an image forming apparatus is a sleep mode or not by a controller; analyzing the instructed instruction form by the controller; when judging the condition of the image forming apparatus as the sleep mode by the controller, on the basis of the analyzed instruction form, referring to a memory section which stores in advance a relationship between the instruction form of image formation and a power supply by both an AC power source and a capacitor to a fixing section or a power supply only by the AC power source to the fixing section; deciding the power supply by both the AC power source and capacitor or the power supply only by the AC power source by the controller; and controlling the power supply to the fixing section.

### BRIEF DESCRIPTION OF THE DRAWINGS

FIG. 1 is a cross sectional view showing the constitution of the image forming apparatus relating to the embodiments of the present invention.

FIG. 2 is a block diagram showing the constitution of the image forming apparatus relating to the embodiments of the present invention.

FIG. 3 is a drawing showing the constitution for supplying power to the fixing section in the embodiments of the present invention.

FIG. 4 is a drawing showing the constitution of the DC power source and controller of the image forming apparatus relating to the embodiments of the present invention.

FIG. 5 is a drawing for explaining the transfer of the condition of the image forming apparatus relating to the embodiments of the present invention.

FIG. 6 is a drawing for explaining the table showing the relationship between the instruction forms of image formation and the possibility of use of the capacitor.

FIG. 7 is a flow chart for explaining a series of operations by the image forming apparatus relating to the embodiments of the present invention.

FIG. 8 is a drawing showing power consumption when supplying power to the fixing section using the capacitor.

FIG. 9 is a drawing showing power consumption when supplying power to the fixing section without using the capacitor.

### DETAILED DESCRIPTION OF THE PREFERRED EMBODIMENTS

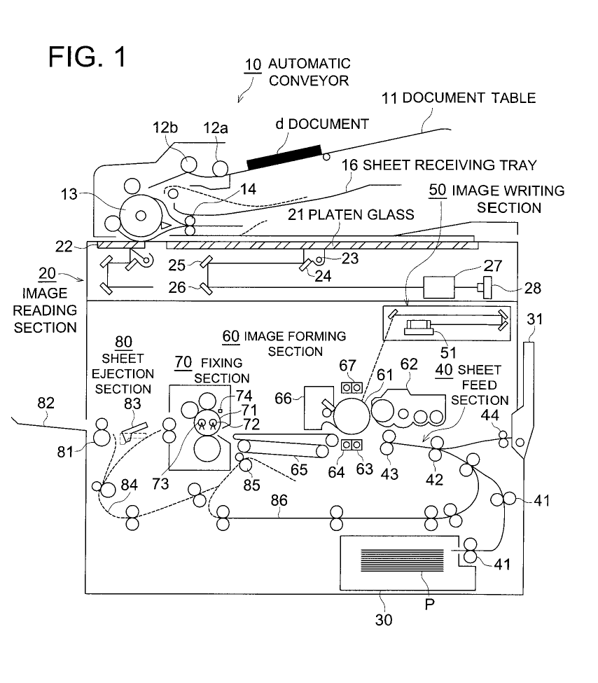

The constitution of the image forming apparatus relating to the embodiments of the present invention will be explained with reference to FIG. 1. FIG. 1 is a cross sectional view showing the constitution of the image forming apparatus relating to the embodiments of the present invention.

An automatic document conveyor 10 conveys a document to read it. On a document table 11 for loading a document, a plurality of documents d with the surface of the first page thereof placed up are loaded. The documents d are sent via a roller 12a and a roller 12b and then are conveyed to an image reader 20 via a roller 13. And, the documents d the image of which is read by the image reader 20 are ejected to a sheet receiving tray 16.

The image reader 20 scans optically a document, thereby generates image data. The surface of each of the documents d is irradiated by a light source 23 and the reflected light thereof forms an image on the light receiving surface of a CCD 28 which is a photoelectric conversion section via mirrors 24, 25, and 26 and a bonding optical system 27. By the way, when loading the documents d on a platen glass 21 with the reading surface thereof directed down and reading it, the optical system scans and reads it along the platen glass 21.

Further, when reading the documents d by conveying them, the light source 23 and mirror 24 are kept fixed under a second platen glass 2. The image data of the read documents d is sent from the CCD 28 to an image processing section (not drawn). Further, when double-side conveying each of the documents d by the automatic conveyor 10, the document d, after the surface is read, is reversed and conveyed by reverse rollers 14 and is conveyed again to the roller 13. And, the back of the document d is read by the image reader 20 and the read image data is sent from the CCD 28 to the image processing section.

A sheet feed tray 30 loads sheets P. Further, in FIG. 1, the sheet feed tray 30 is composed of only one stage, though to load sheets different in size, a sheet feed tray having a plurality of stages may be installed.

A sheet feed section 40 feeds sheets P from the sheet feed tray 30 to an image forming section 60. The sheets P are sent out from the sheet feed tray 30 by feed rollers 41 and are struck against the nip section of registration rollers 43 via loop rollers 42, thereby are stopped once, and the inclination of the sheets P against the conveying direction is corrected. And, the sheets P are conveyed to a transfer section 63 at predetermined timing. Further, the sheets P are sent out from a manual feed tray 31 by feed roller 44 and are conveyed to the transfer section 63 via the same steps.

An image writing section 50, on the basis of the image data of each of the documents d read by the image reader 20, forms an electrostatic latent image on a photoconductor 61 of the image forming section 60. A laser beam according to the image data is irradiated onto the photoconductor 61 of the image forming section 60 from a laser diode 51, thus an electrostatic latent image is formed.

The image forming section 60 forms an image on each of the sheets P by the electrophotographic method. Firstly, onto the photoconductor 61 charged uniformly by a charging section 67, the laser beam from the laser diode 51 of the image reader 50 is irradiated, thus an electrostatic latent image is formed. And, the electrostatic latent image formed on the photoconductor 61 is developed by a developing section 62, thus a toner image is formed on the photoconductor 61. The toner image is transferred to the sheet P by the transfer section 63 installed on the lower part of-the photoconductor 61. And, the sheet P in contact with the photoconductor 61 is separated by a separation section 64. The sheet P separated from the photoconductor 61 is conveyed to a fixing section 70 by a conveying mechanism 65.

The fixing section 70 fixes the toner image transferred onto the sheet P by heat and pressure. Inside a fixing roller 71, a main heating element 72 and a sub-heating element 73 are stored. For the main heating element 72 and sub-heating element 73, for example, a halogen heater is used. Around the fixing roller 71, a temperature detector 74 is installed. The temperature detector 74 detects the temperature of the fixing roller 71. On the basis of a detection signal of the temperature detector 74, supply of power to the fixing section 70 is controlled, thus the temperature of the fixing roller 71 rises to a predetermined temperature and is kept at the predetermined temperature. Further, for the main heating element 72 and sub-heating element 73, in place of the halogen heater, a heating element of an induction heating (IH) type may be used.

A sheet ejection section 80 ejects the sheet P having a formed image. The sheet P having a formed image is ejected onto a sheet receiving tray 82 by sheet exit rollers 81. When forming images on both sides, an image is formed on the surface, and then the sheet P is conveyed downward by a guide 83 and is sent to a reverse path 84. The sheet P entering the reverse path 84 is reversed by reverse conveying rollers 85 and is sent to a reverse conveying path 86. The sheet P entering the reverse conveying path 86 is sent again to the image forming section 60 via the sheet feed section 40.

And, the sheet P is struck against the nip section of the registration rollers 43 via the loop rollers 42, thereby is stopped once, and the inclination of the sheet P against the conveying direction is corrected. Thereafter, the sheet P is conveyed to the transfer section 63 at the predetermined timing.

In the image forming section 60, adhered toner remaining on the photoconductor 61 is removed by a cleaning section 66 and the image forming section 60 is ready for the next image formation. The sheet P is conveyed into the transfer section 63 in this state and an image is formed on the back thereof. And, the sheet P separated from the photoconductor 61 by the separation section 64 is sent again to the fixing section 70 via the conveying mechanism 65 and the toner image is fixed to the sheet P. The sheet P on the surface and back of which images are formed in this way is ejected onto the sheet receiving tray 82 by the sheet ejection rollers 81.

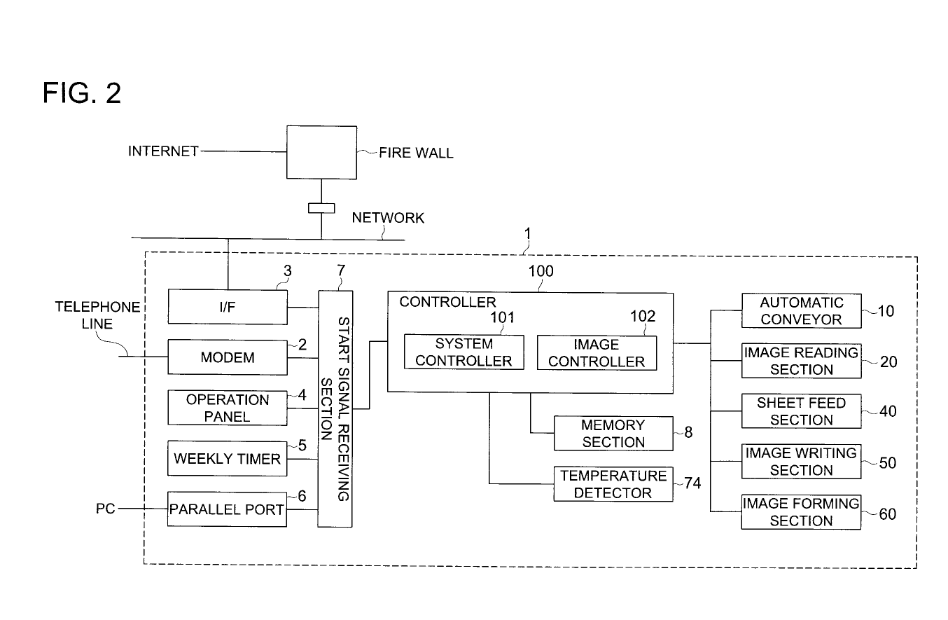

Next, the main control of the image forming apparatus 1 relating to the embodiments of the present invention will be explained by referring to FIG. 2. FIG. 2 is a block diagram showing the constitution of the image forming apparatus relating to the embodiments of the present invention. As shown in FIG. 2, an image forming apparatus 1 includes a MODEM 2, an interface (I/F) 3, an operation panel 4 which is a user interface (UI), a weekly timer 5, and a parallel port 6. Further, the image forming apparatus 1 may have a USB (universal serial bus) port not drawn.

The MODEM 2 can be connected with a telephone line for data communication. The interface 3 is an interface for communicating an electric signal, a magnetic signal, or a light signal for transmitting digital data expressing various types of information via a network. Further, the interface 3 is connected to the Internet and can communicate with an external personal computer (PC) and a facsimile, which are connected to the Internet and are not drawn, by Internet facsimile. The Internet facsimile transmits or receives electronic mail with a facsimile image attached. The operation panel 4 includes a display screen for displaying a predetermined item under the conversation control which will be described later. The weakly timer 5 counts the clock from a clock generator (not drawn) for timing, thereby detects the incoming of the preset day of the weak or the preset time. The parallel port 6 can be connected to data communication with an external personal computer.

Further, the image forming apparatus 1 includes a memory section 8 and a controller 100. The memory section 8 includes a RAM (random access memory) and a rewritable ROM (read only memory) In the memory section 8, information showing the relationship between the instruction form of image formation and the possibility of use of the capacitor is stored. The relationship between the instruction form of image formation and the possibility of use of the capacitor will be described later.

The controller 100 includes a system controller 101 and an image controller 102. The system controller 101 and image controller 102 are made up of a microprocessor such as a CPU. In the memory section 8, a control program is stored beforehand. The controller 100 reads the control program from the memory section 8 and executes the control program, thereby executes the reading control, job management, printer control, conversation control, start signal monitoring control, and power supply control.

The reading control by the controller 100 controls the automatic conveyor 10 so as to convey a document to the image reader 20 and permits the image reader 20 to read the document.

In the job management, the controller 100 receives the image data read by the image reader 20 as a print job. Further, the controller 100 obtains image data via the telephone line and MODEM 2 or via the network and interface 3 and then receives the image data as a print job. The controller 100 manages the execution order on the basis of the priority of the received print jobs.

In the printer control, the controller 100 executes the print job, thereby controls the sheet feed section 40, image writing section 50, image forming section 60, and sheet ejection section 80 and outputs the obtained image data.

In the conversation control, the controller 100 permits the operation panel 4 to display the display screen for setting items relating to the print job and other items by a user. The items relating to the print job are, for example, the items on the sheets relating to the print job (the magnification and reduction ratios, sheet direction, output sheets, sheet feed tray), items relating to output (the output method, number of sheets, sheet receiving tray, sheet ejection mode, sorting, offset), and items relating to bookbinding (binding position, print kind). Other items are for example, the interval of time adjustment, the obtaining method of the reference time, and the execution timing of time adjustment. Further, these items may be added to the image data.

In the start signal monitoring control, the controller 100 monitors from which one among the MODEM 2, interface 3, operation panel 4, weekly timer 5, and parallel port 6 a start signal which is an instruction form of image formation is inputted. A start signal receiving section 7 receives a start signal from the MODEM 2, interface 3, operation panel 4, weekly timer 5, or parallel port 6 and outputs the start signal to the controller 100. And, the system controller 101 receives the start signal and discriminates the input source of the start signal. Further, in this embodiment, the instruction form (start signal) of image formation is equivalent to one example of the information indicating the instruction source instructing the image formation. Further, in the start signal monitoring control, the controller 100, on the basis of the header information included in the start signal, may monitor from which the start signal is inputted.

The weekly timer 5 detects the incoming of the preset day of the weak or the preset time. And, the weekly timer 5, when detecting the incoming of the time, generates a start signal for starting the image forming apparatus 1. Upon receipt of the start signal from the weekly timer 5, the image forming apparatus 1 enters the standby mode capable of forming an image. The start signal inputted from the weekly timer 5 is equivalent to one example of the instruction form of image formation.

In the power supply control, the controller 100 controls power supply to the image forming section 60 and fixing section 70. In this embodiment, the controller 100, on the basis of the information showing the relationship between the instruction form of image formation and the possibility of use of the capacitor which are stored in the memory section 8, controls power supply to the fixing section 70.

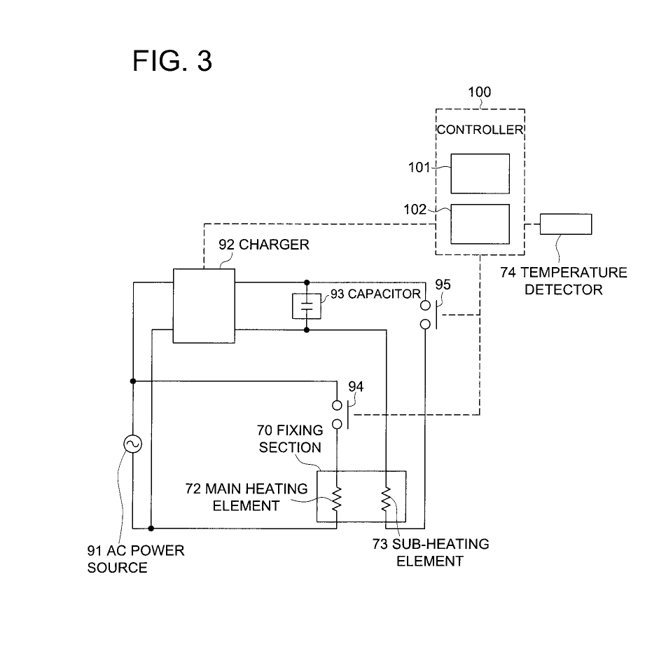

Next, the constitution for supplying power to the fixing section will be explained by referring to FIG. 3. FIG. 3 is a drawing showing the constitution for supplying power to the fixing section in the embodiments of the present invention. As shown in FIG. 3, the main heating element 72 is connected to an AC power source 91 via a switch 94. And, an image controller 102 controls to turn on or off the switch 94. When the switch 94 is turned on by the image controller 102, power is supplied from the AC power source 91 to the main heating element 72. Further, a charger 92 is connected to the AC power source 91. The charger 92 is connected to a capacitor 93 and charges the capacitor 93. The sub-heating element 73 is connected to the capacitor 93 via a switch 95. And, the image controller 102 controls to turn on or off the switch 95. When the switch 95 is turned on by the image controller 102, power is supplied from the capacitor 93 to the sub-heating element 73. Further, the capacitor 93 has a voltage detector not drawn and detects the charging voltage of the capacitor 93. When the detected charging voltage of the capacitor 93 is lower than a predetermined value, the image controller 102 permits the charger 92 to charge the capacitor 93.

Further, the temperature detector 74 is connected to the controller 100 and the temperature of the fixing roller 71 detected by the temperature detector 74 is outputted to the image controller 102. The image controller 102 receives the detection result of the temperature detector 74 and when the temperature of the fixing roller 71 reaches a preset temperature, turns off the switch 94. By doing this, the power supply from the AC power source 91 to the main heating element 72 is stopped.

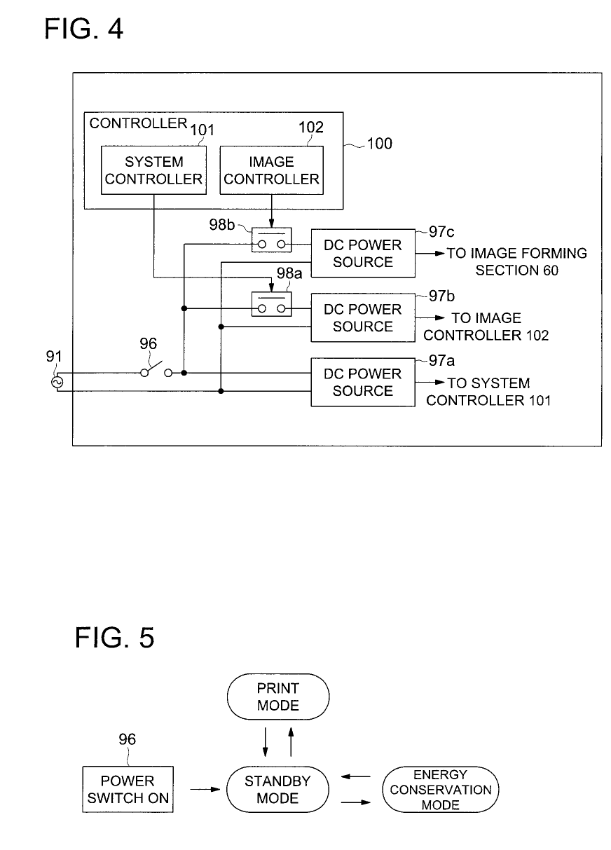

Next, the control for power supply to each section by the controller 100 will be explained by referring to FIG. 4. FIG. 4 is a drawing showing the constitution of the DC power source and controller of the image forming apparatus relating to the embodiments of the present invention. A DC power source 97a is connected to the system controller 101 and supplies a DC voltage to the system controller 101. The DC power source 97a is connected to the AC power source 91 via a power switch 96. When the power switch 96 is turned on, power is supplied from the AC power source 91 to the DC power source 97a. By doing this, the DC power source 97a supplies a DC voltage to the system controller 101. The system controller 101 receives the DC voltage from the DC power source 97a, thereby starts operation. And, the system controller 101 analyzes from where the start signal is inputted.

A DC power source 97b is connected to the image controller 102 and supplies a DC voltage to the image controller 102. The DC power source 97b is connected to the AC power source 91 via a relay 98a and the power switch 96. And, the system controller 101 controls to turn on or off the relay 98a. When the system controller 101 starts operation and receives an instruction of image formation which is input of the start signal, it turns on the relay 98a. By doing this, power is supplied from the AC power source 91 to the DC power source 97b. As a result, the DC power source 97b supplies a DC voltage to the image controller 102. And, the image controller 102 starts operation.

A DC power source 97c is connected to the image forming section 60 and supplies a DC voltage to the image forming section 60. The DC power source 97c is connected to the AC power source 91 via a relay 98b and the power switch 96. And, the system controller 102 controls to turn on or off the relay 98b. When the system controller 102 starts operation, it turns on the relay 98b. By doing this, power is supplied from the AC power source 91 to the DC power source 97c. As a result, the DC power source 97c supplies a DC voltage to the image controller 60. Furthermore, the image controller 102 turns on the switch 94 shown in FIG. 3. By doing this, power is supplied from the AC power source 91 to the main heating element.

Here, the standby mode, energy conservation mode, and print mode will be explained by referring to FIG. 5. FIG. 5 is a drawing for explaining the transfer of the condition of the image forming apparatus relating to the embodiments of the present invention.

As mentioned above, when the power switch 96 shown in FIG. 4 is turned on, power is supplied to the system controller 101 and the system controller 101 turns on the relay 98a. By doing this, a DC voltage is supplied from the DC power source 97b to the image controller 102. And, the image controller 102 turns on the switch 94 shown in FIG. 3. As a result, power is supplied from the AC power source 91 to the main heating element 72 of the fixing section 70 and the fixing section 70 is warmed up. By doing this, the condition of the image forming apparatus 1 is transferred to the “standby mode”.

In the standby mode, when the controller 100 receives an instruction of image formation for a preset period of time, the condition of the image forming apparatus 1 is transferred from the “standby mode” to the “print mode”. In the print mode, the image controller 102 controls to turn on or off the switch 94 shown in FIG. 3, thereby controls power supply from the AC power source 91 to the main heating element 72 of the fixing section 70. And, when the image output included in the print job is finished, the condition of the image forming apparatus 1 is transferred from the “print mode” to the “standby mode”.

Further, in the standby mode, when the controller 100 does not receive the instruction of image formation for the preset period of time, the condition of the image forming apparatus 1 is transferred from the “standby mode” to the “energy conservation mode”. In the energy conservation mode, the image controller 102 turns off the switch 94 shown in FIG. 3, thereby stops the power supply to the fixing section 70. Namely, when the controller 100 does not receive the instruction of image formation for the preset period of time, the image controller 102 turns off the switch 94. By doing this, the power supply from the AC power source 91 to the main heating element 72 is stopped. Further, the switch 95 is kept off, so that the power supply from the capacitor 93 to the sub-heating element 73 is stopped.

Furthermore, in the energy conservation mode, the system controller 101 turns off the relay 98a shown in FIG. 4. By doing this, the supply of the DC voltage from the DC power source 97a to the image controller 102 is stopped. As a result, the supply of the DC voltage to the image controller 102 and image forming section 60 is stopped. As mentioned above, in the energy conservation mode, the power supply to the image controller 102, image forming section 60, and fixing section 70 is stopped.

And, in the energy conservation mode, when the controller 100 receives the instruction of image formation, the system controller 101 turns on the relay 98a shown in FIG. 4. By doing this, the image controller 102 starts operation and turns on the relay 98b shown in FIG. 4. As a result, a DC voltage is supplied to the image forming section 60. Furthermore, the image controller 102 turns on the switch 94 shown in FIG. 3. Power is supplied from the AC power source 91 to the main heating element 72 and the fixing section 70 is warmed up. By doing this, the condition of the image forming apparatus 1 is transferred from the energy conservation mode to the standby mode.

When transferring the condition of the image forming apparatus 1 from the energy conservation mode to the standby mode, in this embodiment, there are cases available that both power sources of the AC power source 91 and capacitor 93 are used (as one power supply method) and only the AC power source 91 is used without using the capacitor 93 (as another power supply method). In this embodiment, depending on the instruction form of image formation, power is supplied to the fixing section 70 using both power sources or power is supplied to the fixing section 70 using only the AC power source 91 is decided.

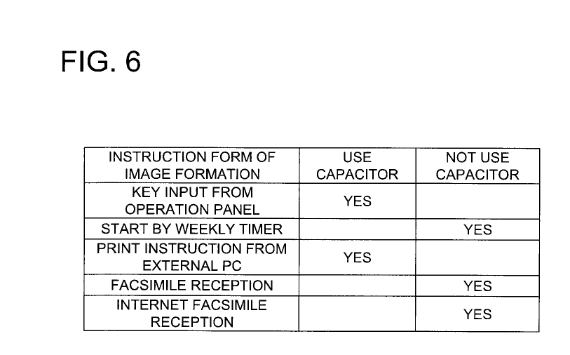

Here, the relationship between the instruction form of image formation (instruction source of image formation) and the possibility of use of the capacitor will be explained by referring to FIG. 6. FIG. 6 is a drawing for explaining the table showing the relationship between the instruction form of image formation and the possibility of use of the capacitor.

As shown in FIG. 6, the relationships between the instruction forms of image formation (instruction sources of image formation) and the possibility of use of the capacitor is stored in the memory section 8 as a table. In the table, the instruction forms of image formation (instruction sources of image formation) and the possibility of use of the capacitor 93 are listed. Regarding the possibility of use of the capacitor, depending on the instruction form of image formation, use of both the AC power source 91 and capacitor 93 or use of only the AC power source without using the capacitor 93 is decided.

The system controller 101, upon receipt of the instruction of image formation, refers to the table stored in the memory section 8, thereby decides the power supply method according to the instruction form. And, the image controller 102, according to the decision of the system controller 101, controls to turn on or off the switches 94 and 95 shown in FIG. 3.

In the table shown in FIG. 6, when use of the capacitor 93 is decided, the capacitor 93 is used to supply power to the fixing section 70. In the table shown in FIG. 6, when the instruction form of image formation is key input from the operation panel 4 or a print instruction from an external PC via the parallel port 6, the AC power source 91 and capacitor 93 are used to supply power to the fixing section 70.

When using both the AC power source 91 and capacitor 93, the image controller 102 turns on the switches 94 and 95. By doing this, a voltage is supplied from the AC power source 91 to the main heating element 72 and moreover, a voltage is supplied from the capacitor 93 to the sub-heating element 73.

On the other hand, in the table shown in FIG. 6, when non-use of the capacitor 93 is decided, the capacitor 93 is not used to supply power to the fixing section 70. In the table shown in FIG. 6, when the instruction form of image formation is a facsimile via the MODEM 2, an Internet facsimile via the interface 3, or start of the weekly timer 5, only the AC power source 91 is used to supply power to the fixing section 70.

When using only the AC power source without using the capacitor 93, the image controller 102 turns on the switch 94 and turns off the switch 95. By doing this, a voltage is supplied from the AC power source 91 to the main heating element 72. The switch 95 is kept off, no voltage is supplied from the capacitor 93 to the sub-heating element 73. As a result, power is supplied only from the AC power source to the fixing section 70.

As mentioned above, according to the instruction form of image formation (instruction source of image formation), power is supplied to the fixing section 70 by both the AC power source 91 and capacitor 93 or power is supplied to the fixing section 70 only by the AC power source, thus according to the instruction form of image formation (instruction source of image formation), the power loss due to the capacitor 93 can be reduced. Therefore, the energy conservation can be promoted.

For example, when an instruction of image formation requiring no rapid warm-up as an instruction of image formation by facsimile reception is received, the necessity of using the capacitor 93 is low. In this case, by supplying power to the fixing section 70 only by the AC power source 91, the power loss due to the capacitor 93 can be reduced. Namely, when rapid warm-up is not necessary, by avoiding an unnecessary power loss, the energy conservation can be promoted.

On the other hand, when an instruction of image formation requiring rapid warm-up is received, power supply to the fixing section 70 using the AC power source 91 and capacitor 93 can respond to the requirement of rapid warm-up.

As mentioned above, depending on the instruction form of image formation (instruction source of image formation), the necessity of rapid warm-up is changed, so that the power supply method is changed according to the instruction form of image formation (instruction source of image formation), thus the apparatus can respond to the requirement of rapid warm-up or the energy conservation can be promoted.

Operation

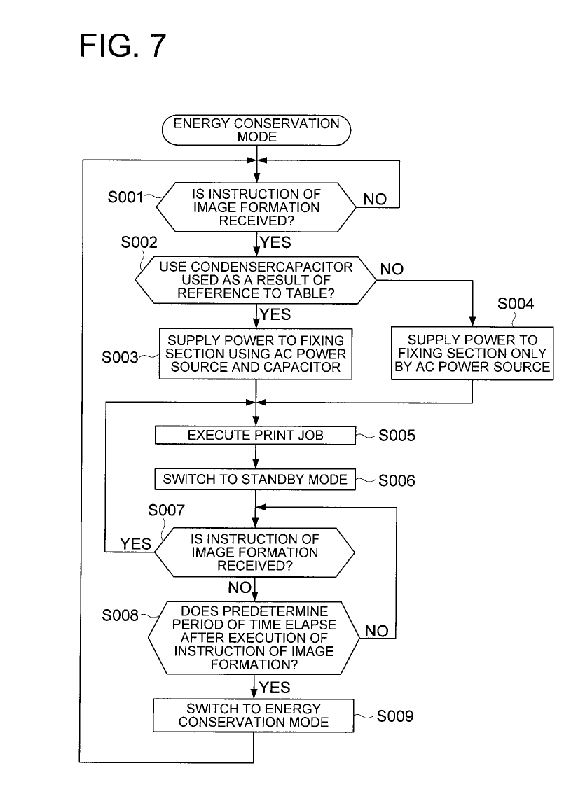

Next, the operation of the image forming apparatus 1 relating to the embodiments of the present invention will be explained by referring to FIG. 7. FIG. 7 is a flow chart for explaining a series of operations by the image forming apparatus relating to the embodiments of the present invention.

Step S001

The system controller 101 shown in FIG. 2 monitors from where the start signal is inputted. And, when the start signal is inputted and the system controller 101 receives the start signal (Yes at Step S001), the process moves to Step S002. Namely, when the system controller 101 receives an instruction of image formation, the process moves to Step S002.

Step S002

The system controller 101, upon receipt of the instruction of image formation, refers to the table stored in the memory section 8, thereby decides the power supply method corresponding to the instruction form (instruction source of image formation).

Furthermore, the system controller 101 turns on the relay 98a shown in FIG. 4. By doing this, a DC voltage is supplied from the DC power source 97b to the image controller 102 and the image controller 102 starts operation.

Step S003

The image controller 102, according to the power supply method instructed by the system controller 101, controls the power supply to the fixing section 70. For example, with the result that the system controller 101 refers to the table shown in FIG. 6, for the possibility of use of the capacitor 93 corresponding to the instruction form of image formation (instruction source of image formation), when use of the capacitor 93 is decided, the image controller 102 permits the fixing section 70 to warm up using the capacitor 93. Namely, the image controller 102 supplies power to the fixing section 70 using the AC power source 91 and capacitor 93 shown in FIG. 3. Concretely, the image controller 102 turns on the switches 94 and 95 shown in FIG. 3. By doing this, power is supplied from the AC power source 91 to the main heating element 72 and furthermore, power is supplied from the capacitor 93 to the sub-heating element 73. By doing this, the temperature of the fixing section 70 rises comparatively quickly to a predetermined temperature.

Step S004

On the other hand, with the result that the system controller 101 refers to the table shown in FIG. 6, for the possibility of use of the capacitor 93 corresponding to the instruction form of image formation (instruction source of image formation), when non-use of the capacitor 93 is decided, the image controller 102 permits the fixing section 70 to warm up not using the capacitor 93. Namely, the image controller 102 supplies power to the fixing section 70 only using the AC power source 91 shown in FIG. 3 but not using the capacitor 93. Concretely, the image controller 102 turns on the switch 94 shown in FIG. 3 and turns off the switch 95. By doing this, power is supplied from the AC power source 91 to the main heating element 72. The switch 95 is kept off, so that no power is supplied from the capacitor 93 to the sub-heating element 73.

As mentioned above, when only the AC power source 91 is used, there is no need to supply power from the charger 92 to the capacitor 93. Therefore, to maintain a predetermined charging quantity by the capacitor 93, the AC power source 91 can avoid supply power to the charger 92. As a result, no power loss due to the power conversion efficiency of the charger 92 will be caused. Further, by use of only the AC power source 91, the time required for the temperature of the fixing section 70 to rise to a predetermined temperature is prolonged.

Step S005

And, the image forming apparatus 1 executes the print job. Namely, the sheet feed section 40 feeds the sheets P from the sheet feed tray 30 to the image forming section 60. The image writing section 50, on the basis of the image data included in the print job, forms an electrostatic latent image on the photoconductor 61 of the image forming section 60. And, the image forming section 60 forms a toner image from the electrostatic latent image formed on the photoconductor 61 and transfers the toner image onto the sheet P. Thereafter, the toner image transferred onto the sheet P is fixed by the fixing section 70. And, the sheet P having the formed image is ejected onto the sheet receiving tray 82. Further, when an instruction of formation of a plurality of images is included in the print job, the image forming apparatus 1 executes formation of the plurality of images.

Step S006

When the execution of the print job is finished, the condition of the image forming apparatus 1 is transferred from the print mode to the standby mode. Namely, the image controller 102 turns off the switch 94 shown in FIG. 4. By doing this, the power supply from the AC power source 91 to the main heating element 72 is stopped.

Step S007

When the controller 100 receives an instruction of image formation in the standby mode (Yes at Step S007), the controller 100 executes the processes at Steps S005 and S006 aforementioned.

Step S008

And, the controller 100, after execution of the print job, judges repeatedly whether the predetermined time elapses or not. When the predetermined time elapses (Yes at Step S008), the process moves to Step S009.

Step S009

When the predetermined time elapses after execution of the print job, the condition of the image forming apparatus 1 is transferred from the standby mode to the energy conservation mode. Namely, the image controller 102 turns off the switch 94 shown in FIG. 3. By doing this, the power supply to the fixing section 70 is stopped. Furthermore, the system controller 101 turns off the relay 98a. By doing this, the power supply to the image controller 102 and image forming section 60 is stopped. As mentioned above, in the energy conservation mode, the power supply to the image controller 102, image forming section 60, and fixing section 70 is stopped.

Comparative Example of Power Consumed

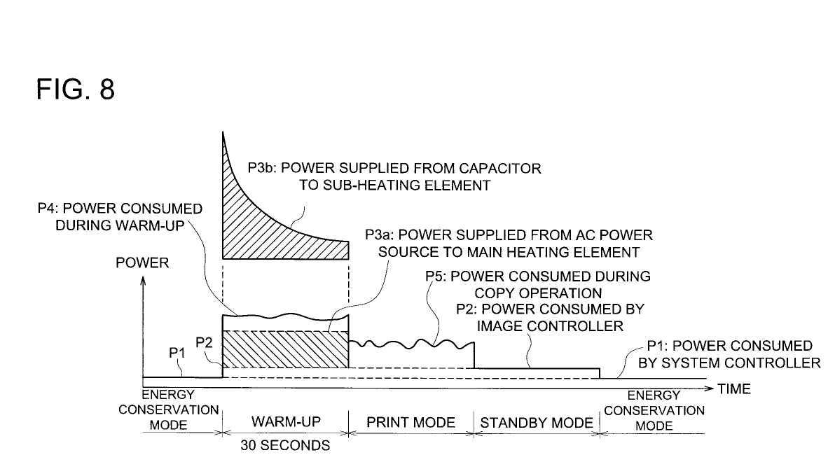

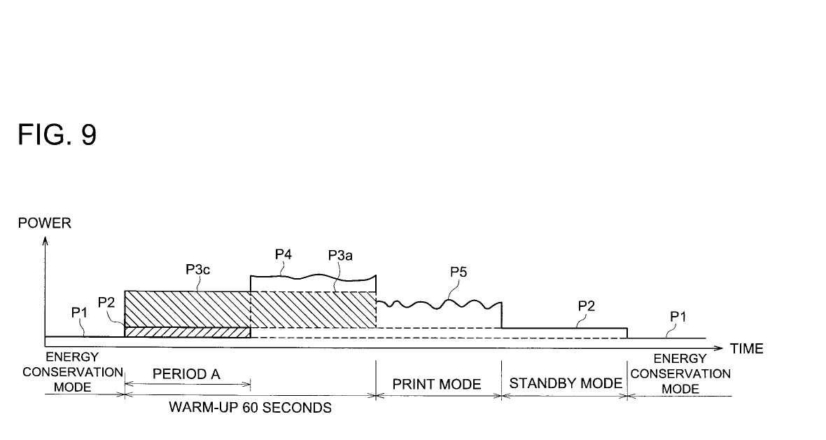

Next, when warming up the image forming apparatus from the energy conservation mode to the standby mode, an example of power consumed by the image forming apparatus will be explained by referring to FIGS. 8 and 9. FIG. 8 is a drawing showing power consumption when supplying power to the fixing section using the capacitor. FIG. 9 is a drawing showing power consumption when supplying power to the fixing section without using the capacitor. In FIGS. 8 and 9, the horizontal axis indicates time and the vertical axis indicates power consumed. Concretely, FIGS. 8 and 9 show power consumed in each mode. In FIGS. 8 and 9, as an example, the case that the image forming apparatus is transferred from the energy conservation mode to the standby mode and print mode by warm-up, then is transferred from the print mode to the standby mode, and furthermore is transferred from the standby mode to the energy conservation mode will be explained.

In FIGS. 8 and 9, power P1 is power consumed by the system controller 101. The power P1 is power consumed in the energy conservation mode, at time of warm-up, in the print mode, and in the standby mode. Further, power P2 is power consumed at time of warm-up, in the print mode, and in the standby mode. Further, power P3a is power supplied from the AC power source 91 to the main heating element 72 of the fixing section 70. Power P3b is power supplied from the capacitor 93 to the sub-heating element 73 of the fixing section 70. The power P3a and power P3b are power consumed during warm-up. Further, power P4 is power consumed by the image forming section 60 during warm-up. Further, power P5 is power consumed by the image forming section 60 and fixing section 70 at time of image output.

Here, the case that a black and white 75-cpm apparatus is used as an image forming apparatus 1 will be explained. For example, the warm-up time is assumed as 30 seconds and for the main heating element 72, a heater of 1000 [W] or so is used. In this case, at time of warm-up, the necessary total quantity of power supplied from the capacitor 93 to the sub-heating element 73 is about 30000 [J].

When the capacitor 93 is used for power supply during warm-up, it is accompanied by a power loss in correspondence to the power conversion efficiency of the charger 92. For example, the power conversion efficiency of the charger 92 is about 70%, so that when power is supplied from the charger 92 to the sub-heating element 73, since 30000/0.7−30000≈13000, energy of about 13000 [J] is lost every warm-up.

On the other hand, as shown in FIG. 9, when the capacitor 93 is not used for power supply during warm-up, it can avoid accompaniment by a power loss due to the charger 92. In the example shown in FIG. 9, during warm-up, power supply to the image forming section 60 is retarded than power supply to the image controller 102. To retard power supply to the image forming section 60, for example, after the fixing roller 71 starts a predetermined operation, power may be supplied from the AC power source 91 to the image forming section 60. In the example shown in FIG. 9, during warm-up, in the first period A, power is supplied to the image controller 102 and fixing section 70. And, when the period A expires, power is started to be supplied to the image forming section 60 and the fixing section 70 and image forming section 60 are warmed up.

The power P3c consumed during the period A, during warm-up, is power supplied from the AC power source 91 to the main heating element 72 of the fixing section 70. The power P3c is equivalent to the power supplied from the capacitor 93. When the capacitor 93 is not used, for a longer period of time than that when the capacitor 93 is used, power is supplied from the AC power source 91 to the main heating element 72 of the fixing section 70, thus the image forming apparatus is warmed up. In the example shown in FIG. 9, the time required for warm-up is 60 seconds. And, during warm-up, the consumption power is increased in correspondence to the power supplied to the image controller 102 during the period A. In the example shown in FIG. 9, the power increased is about 50 [W]. When the period A is about 30 seconds, energy of about 1500 [J] is consumed.

Therefore, when the capacitor 93 is not used during warm-up, compared with the case that the capacitor 93 is used, since 13000−1500=11500, a loss of energy of 11500 [J] can be avoided.

Further, when supplying power to the fixing section 70 without using the capacitor 93, in this example, the warm-up takes 60 seconds. Namely, it takes 60 seconds to transfer to the printer mode. The period of time 60 seconds, from the nature of a facsimile or an Internet facsimile, is within the time range for which a user can wait.

When the capacitor 93 is not used during warm-up as mentioned above, the energy loss can be reduced more than that when the capacitor 93 is used. Therefore, in the case that quick warm-up is not necessary such as reception of a facsimile, by warming up without using the capacitor 93, the energy loss of the image forming apparatus 1 is reduced, thus the energy conservation can be promoted.

According to the embodiment aforementioned, according to the instruction form of image formation, power is supplied from both the AC power source and capacitor to the fixing section or power is supplied only from the AC power source to the fixing section. When changing the power supply method to the fixing section according to the instruction form of image formation like this, the power loss due to the capacitor can be reduced.

For example, when an instruction of image formation is received by a facsimile, power is supplied only from the AC power source to the fixing section, thus when an instruction of image formation is received by a facsimile, the power loss due to the capacitor can be reduced.

What is claimed is:

1. An image forming apparatus provided with an image forming section and a fixing section, comprising:
a memory section which stores relationships between a plurality of instruction forms of image formation and a plurality of power supply methods including a power supply by both an AC power source and a capacitor to the fixing section and a power supply only by the AC power source to the fixing section; and
a controller, when receiving an instruction of image formation, that refers to the memory section on a basis of an instruction form of the received instruction of image formation and supplies power by both the AC power source and capacitor to the fixing section, or supplies power only by the AC power source to the fixing section.

2. The image forming apparatus of claim 1, wherein each of the plurality of instruction forms is information indicating an instruction source of image formation.

3. The image forming apparatus of claim 1, wherein
the plurality of instruction forms include an instruction form of image formation instructed by a key input from an operation panel of the image forming apparatus and an instruction form of image formation instructed by facsimile reception;
the memory section stores a relationship between the instruction form of image formation instructed by the key input and the power supply by both the AC power source and the capacitor to the fixing section and a relationship between the instruction form of image formation instructed by facsimile reception and the power supply only by the AC power source to the fixing section; and
the controller, when receiving an instruction of image formation instructed by the key input, refers to the memory section on a basis of an instruction form of the received instruction of image formation and supplies power by both the AC power source and the capacitor to the fixing section, and when receiving an instruction of image formation instructed by the facsimile reception, refers to the memory section on a basis of an instruction form of the received instruction of image formation and supplies power only by the AC power source to the fixing section.

4. The image forming apparatus of claim 2, wherein
the plurality of instruction forms include an instruction form of image formation instructed by a key input from an operation panel of the image forming apparatus and an instruction form of image formation instructed by facsimile reception;
the memory section stores a relationship between the instruction form of image formation instructed by the key input and the power supply by both the AC power source and the capacitor to the fixing section and a relationship between the instruction form of image formation instructed by facsimile reception and the power supply only by the AC power source to the fixing section; and
the controller, when receiving an instruction of image formation instructed by the key input, refers to the memory section on a basis of an instruction form of the received instruction of image formation and supplies power by both the AC power source and the capacitor to the fixing section, and when receiving an instruction of image formation instructed by the facsimile reception, refers to the memory section on a basis of an instruction form of the received instruction of image formation and supplies power only by the AC power source to the fixing section.

5. The image forming apparatus of claim 1, wherein the plurality of instruction forms of image formation include an instruction form of image formation instructed by a facsimile reception, an instruction form of image formation instructed by Internet facsimile reception and an instruction form of image formation instructed by a weekly timer, and wherein the memory section stores in advance relationships between each of the instruction form of image formation instructed by the facsimile reception, the instruction form of image formation instructed by the Internet facsimile reception and the instruction form of image formation instructed by the weekly timer and a power supply only by the AC power source to the fixing section.

6. The image forming apparatus of claim 2, wherein the plurality of instruction forms of image formation include an instruction form of image formation instructed by a facsimile reception, an instruction form of image formation instructed by Internet facsimile reception and an instruction form of image formation instructed by a weekly timer, and wherein the memory section stores in advance relationships between each of the instruction form of image formation instructed by the facsimile reception, the instruction form of image formation instructed by the Internet facsimile reception and the instruction form of image formation instructed by the weekly timer and a power supply only by the AC power source to the fixing section.

7. The image forming apparatus of claim 3, wherein the plurality of instruction forms of image formation include an instruction form of image formation instructed by a facsimile reception, an instruction form of image formation instructed by Internet facsimile reception and an instruction form of image formation instructed by a weekly timer, and wherein the memory section stores in advance relationships between each of the instruction form of image formation instructed by the facsimile reception, the instruction form of image formation instructed by the Internet facsimile reception and the instruction form of image formation instructed by the weekly timer and a power supply only by the AC power source to the fixing section.

8. An image forming method comprising:
receiving an instruction of image formation and judging whether a condition of an image forming apparatus is a sleep mode or not by a controller;
analyzing the instructed instruction form by the controller;
when judging the condition of the image forming apparatus as the sleep mode by the controller, on the basis of the analyzed instruction form, referring to a memory section which stores in advance a relationship between the instruction form of image formation and a power supply by both an AC power source and a capacitor to a fixing section or a power supply only by the AC power source to the fixing section;
deciding the power supply by both the AC power source and capacitor or the power supply only by the AC power source by the controller; and
controlling the power supply to the fixing section.
